(19) United States
(12) Patent Application Publication
(10) Pub. No.: US 2021/0323240 A1
(43) Pub. Date: Oct. 21, 2021

(54) THREE DIMENSIONAL PRINTING

(71) Applicant: Hewlett-Packard Development Company, L.P., Spring, TX (US)

(72) Inventors: David A. CHAMPION, Corvallis, OR (US); Anthony Peter HOLDEN, Corvallis, OR (US); Douglas PEDERSON, Corvallis, OR (US)

(21) Appl. No.: 17/272,589

(22) PCT Filed: Apr. 22, 2019
(86) PCT No.: PCT/US2019/028547

§ 371 Date: Mar. 1, 2021

(51) Int. Cl. B29C 64/393; B33Y 10/00; B33Y 30/00; B33Y 50/02; B29C 64/165; B29C 64/277; B29C 64/227

(52) U.S. Cl. CPC B29C 64/393; B33Y 10/00; B33Y 30/00; B29C 64/227; B29C 64/165; B29C 64/277; B33Y 50/02

(57) ABSTRACT

An example three-dimensional printing system receives a sensor response indicating a density of build material at positions of a layer of build material on a build platform. The three-dimensional printing system determines, based on the sensor response, an amount of energy to apply to the positions and instructs an energy source to apply the determined amount of energy to the positions.

### BACKGROUND

Some three-dimensional (3D) printing systems generate 3D objects by selectively solidifying successive layers of a build material formed on a movable build platform. Some such systems, for example, selectively apply, or print, an energy absorbent fusing agent onto a formed layer of build material based on a 3D object model of the object to be generated. Energy is then applied, from a suitable energy source, to the layer of build material which causes those portions of the build material layer on which fusing agent was applied to heat up sufficiently to melt, sinter, or otherwise fuse together, thereby forming a layer of a 3D object being generated. The wavelengths of energy absorbed by the fusing agent may be generally matched to the wavelengths emitted by the energy source. For example, systems may use infrared, ultra-violet, or other electromagnetic energy to fuse the build material.

### BRIEF DESCRIPTION OF THE DRAWINGS

Examples will now be described, by way of non-limiting example, with reference to the accompanying drawings, in which:

FIG. 1 is a simplified side view illustration of a 3D printing system according to one example;

FIG. 2 a simplified top view illustration of a 3D printing system according to one example;

FIG. 3 is a block diagram of a 3D printer controller according to one example; and

FIG. 4 is a flow diagram outlining an example method of controlling a 3D printing system according to one example.

### DETAILED DESCRIPTION

In an example powder-based 3D printing process, build material is deposited on a surface of a build platform. A fusing agent is then selectively applied to the powder in areas that are to be fused. Then energy is applied to cause the build material to melt, sinter, or otherwise fuse where the fusing agent was applied. The process is repeated by applying additional build material in successive layers.

In such a powder-based 3D printing process, an energy source may be instructed by a controller to apply a determined amount of energy to the build material. The amount of energy to apply may be based in part on the build material and fusing agent. For example, a controller may have a baseline amount of energy to apply to fuse build material at a particular location. However, the actual amount of applied energy to cause fusing at a particular location may depend on a number of characteristics of the 3D model, the energy source (such as lasers, microwave tip emitters, vertical-cavity surface-emitting lasers, or the like), the build material, the fusing agent, or the like. For example, fusing build material in a location adjacent to an already fused location may require less energy to fuse to residual heating from the already fused location.

However, the determination and application of an amount of energy to apply based on such factors may result in over-heating or under-heating of portions of the build material. For example, differences in density of build material across a layer of build material may affect the amount of energy that is needed to adequately fuse the build material. While a target for distribution of build material may be to distribute the material evenly across a build platform, inconsistencies in distribution may generate locations with lower or higher densities than the target density. For example, a layer of build material may have local densities ranging from 40-60% build material. In some examples, having a higher or lower build material density changes the amount of energy that is required to cause fusing based on the amount of fusing agent applied. Applying too little energy can cause incomplete fusing of selected locations of the build material resulting in a fabricated object having substandard properties. For example, mechanical strength, modulus, or other properties may be affected. Accordingly, in order to ensure fusing, a 3D printing system can apply energy at a level to cause fusing across the range of expected densities. However, applying too much energy can cause inaccuracies to fused areas by heating unintended regions and causing fusing at locations without fusing agent applied. Application of too much energy or overheating may also cause excess aging of the build material in non-selected locations of the layer of build material.

In order to avoid defects due to over-heating or under-heating of build material during printing, varying the energy applied to a layer of build material based on local build material densities at selected positions enables providing the appropriate energy based on density. To apply an amount of energy to fuse selected locations without overheating, systems disclosed herein use a sensor bar to generate an indication of the density of the build material at selected locations and then apply energy based on the density determined at those selected locations.

The sensor bar may include an array of sensors, such as microwave sensors. The sensor bar may be moved across a build platform after a layer of build material has been distributed on the build platform. The sensors may determine a density at locations as they are moved across the build platform and provide the density measurements to a controller. The controller may store the density and the associated position. A fusing agent distributor then selectively applies a fusing agent based on a 3D model as the distributor is moved across the build platform behind the sensor bar. Finally, an energy source moved across the build platform behind the fusing agent distributor applies energy as indicated by the controller.

The controller may vary the amount of energy it instructs an energy source to apply to each position based on the density measured at that position by the sensor bar. For example, the energy source may be an array of energy emitters, such as microwave energy emitters, vertical-cavity surface-emitting laser, or the like. The controller may determine an amount of energy to apply at each position based on the density and instruct a corresponding microwave energy emitter to apply that energy to the position. In some examples, the controller selectively instructs energy application to positions having fusing agent applied and not to positions that have no fusing agent applied. The controller may also instruct multiple energy emitters to apply energy to one location to generate temperatures to cause fusing.

As described herein, density refers to the amount of build material within a unit of volume. The density may be represented as a percentage of the overall volume. The variation in density of the build material may be affected by the position within a build platform, variations in the build material itself, effects of build material spreading, or other disparities in the composition or spreading of the build material. As further described, the build material may be measured prior to application of a fusing agent to increase accuracy of the measurement and subsequent energy application.

The systems described generally reference microwave energy application and measurement of particle density. In various examples, additional or different sensors may be used to measure density of applied build material. For example, optical, infrared, ultraviolet, or other sensing devices may be used alone or in combination to determine an indication of build material density. Furthermore, additional or different energy sources may be used to cause fusing of the build material. For example, a heat source or other electromagnetic spectrum source may be used to apply energy to the build material with a fusing agent applied. Similarly, other fusing agents may be selected for application based on the type of energy source.

The sensor bar of microwave energy emitters may emit energy into the layer of build material and measure characteristics of the response to determine an impedance or other indication of density of the build material. In some examples, the sensor bar is moved across the build platform prior to application of fusing agent. Therefore, the sensor bar may provide an indication of density without the interfering effects of the fusing agent on the resulting measurements from the sensor bar.

In some examples, a fusing agent distributor and two arrays of microwave energy emitters are mounted to a carriage and moved across a build platform in a first direction. One of the microwave energy emitter arrays may be on a leading side of the fusing agent distributor and the other on the trailing side of the fusing agent distributor in the direction of motion. The microwave energy emitter array on the leading side may act as a sensor bar to measure density in a number of positions as it is moved across the build platform. The fusing agent distributor then selectively applies fusing agent to the layer of build material according to a 3D model. The microwave energy emitter array on the trailing edge then selectively applies energy to the layer of build material to cause the build material to heat and fuse in areas having the fusing agent applied. The amount of energy applied is determined based at least in part of the density measurement from the microwave tip array on the leading side of the fusing agent distributor. In order to enable bi-directional printing, the role of the microwave energy emitters may be switched as the carriage moves in a second direction. For example, the microwave energy emitter array that was on the trailing side in a first scan direction may be on the leading side and act as a sensor in a second scan direction while the microwave energy emitter array that was on the leading side in the first scan direction may not be on the trailing side and apply energy based on the determined indications of density at positions in the layer of build material in the second scan direction.

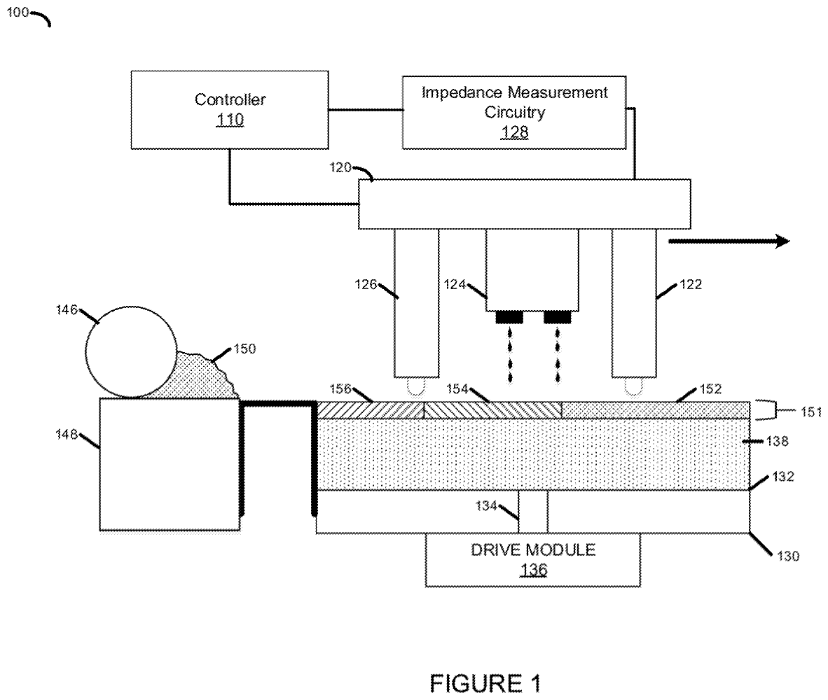

FIG. 1 is a block diagram illustrating an example 3D printing system 100 having a sensor bar 122 to sense density of build material 150 and a controller 110 to determine an amount of energy to apply by an energy source 126. The process of applying build material 150 and selectively fusing portions of the build material 150 is repeated in multiple layers to generate a 3D object based on a 3D model. Determining an appropriate amount of energy to apply by an energy source 126 during a fusing operation prevents undesirable effects of over-heating build material 150 that is not intended to be fused or under-fusing build material 150 that is intended to be fused.

As illustrated in FIG. 1, the 3D printing system 100 is in the process printing a 3D object. At this stage in the process, build unit 130 of the 3D printing system 100 holds a processed portion of build material 138 by instructing the fusing agent distributor 124 to apply a fusing agent at selected positions and fusing the build material by applying energy from energy source 126. The 3D printing system 100 has then applied a new layer of build material 151 above the processed portion of build material 138. The controller 110 may then determine instructions for processing the new layer of build material 151.

In some examples, the controller 110 may be a semiconductor-based microprocessor, a central processing unit (CPU), an application specific integrated circuit (ASIC), a field-programmable gate array (FPGA), and/or other suitable hardware device. In some examples, the controller 110 may be separate from the 3D printing system 100 while in other examples, the controller 110 may be incorporated with the 3D printing system 100. The 3D printing system 100 may also be termed a 3D printer, a 3D fabricator, an additive manufacturing system, or the like, and may be implemented to fabricate 3D objects from build material 150 as discussed herein.

The build material 150 may be formed into a layer of build material 151 and the 3D printing system 100 may cause build material 150 at selected locations of the layer of build material 151 to melt, fuse, sinter, or otherwise coalesce. The selected locations of the layer of build material 151 may include the locations that are to be coalesced to form a part of a 3D object or parts of multiple 3D objects in the layer of build material 151. By selectively coalescing the build material 150 at selected locations on multiple build material layers, the parts of the 3D object or 3D objects may be fabricated according to a model. As used herein, fusing may indicate any processes joining build material 150 through melting and subsequent coalescing, through curing of a binder, or otherwise selectively joining material.

The 3D printing system 100 also includes a include fusing agent distributor 124 that may deliver a fusing agent to the selected locations of the layer of build material 151. For instance, the controller 110 may control the fusing agent distributor 124 to selectively deliver the fusing agent at the selected locations as the fusing agent distributor 124 is scanned across the layer of build material 151. The 3D printing system 100 also includes a sensor bar 122 and an energy source 126. In some examples, the sensor bar 122 and the energy source 126 each include an array of microwave energy emitters. The microwave energy emitters may each include a tip to generate a focused energy field that may be selectively applied to the layer of build material 151. For example, the sensor bar 122 and energy source 126 may be positioned sufficiently close to the layer of build material 151 to place a portion of the layer of build material 151 within the generated focused energy field. In some examples, the tip microwave energy emitters may have tips of a relatively small diameter, e.g., between about 2 mm and about 4 mm, to focus the microwave energy. In some examples, the energy source 126 may provide electromagnetic radiation with a wavelength that may be between about 1 meter and about one millimeter and having a frequency that may be between about 300 MHz and about 300 GHz. In various examples, an energy sources 126 may apply other electromagnetic frequencies or other forms of energy to the layer of build material 151 to fuse the build material 150.

In some examples, the controller 110 controls delivery of a first signal through microwave energy emitters of sensor bar 122. The controller 110 may control delivery of the first signal to the sensor bar 122 at a position prior to the application of fusing agent by fusing agent distributor 124. Accordingly, the presence or absence of fusing agent at a particular position will not impact a measurement taken by the sensor bar 122. The first signal may act as a probe signal which may be reflected or refracted by the build material 150 in a manner to determine an impedance of the build material 150. The impedance may then be used by the controller 110 to determine a density or indication of density that can be used to determine an amount of energy to apply by the energy source 126 at that position.

The impedance measurement circuitry 128 may receive an energy feedback signal corresponding to energy reflected back into the microwave energy emitters of the sensor bar 122. That is, as the microwave energy is applied to the selected location, energy may be reflected back (or equivalently, returned) from the layer of build material 151 at the selected location. The phase and amplitude of the reflected energy may be affected by the density of the layer of build material 151 at the selected location. The amount of energy reflected may change according to the application of a fusing agent. Accordingly, the sensor bar 122 generates an indication of the density of the layer of build material 151 prior to application of the fusing agent to generate more accurate representations of the build material density.

The impedance measurement circuitry 128 may include circuitry to measure intensity and/or phase of reflected energy. The measurement may then be converted by the impedance measurement circuitry 128 or the controller 110 into an indication of density of the layer of build material 151. In some examples, the impedance measurement circuitry 128 may measure the density at the surface of the layer of build material 151 or a layer near the surface of the layer of build material 151 that is less than the entire layer. The indication of density therefore may assume some uniformity within the layer of build material 151 at a particular position.

As shown in FIG. 1, the layer of build material 151 is shown as a first portion 152 that does not have fusing agent applied, a second portion 154 that has fusing agent selectively applied based on a 3D model, and a third portion 156 that has been selectively fused based on the 3D model. A completed layer of build material would include a selectively fused portion after the snapshot shown in FIG. 1. The sensor bar 122 generates an indication of density at a number of positions in the first portion 152 of the layer of build material. The density measurements can then be used by the controller 110 to determine an amount of energy to be applied by energy source 126. For example, the controller 110 may provide additional energy in areas with lower density than areas with higher density. In some examples, based on properties of build material 150, the controller may provide less energy in areas with lower density than areas with higher density. Applying the determined amount of energy from energy source 126 causes portions of the layer of build material on which fusing agent was applied to heat up sufficiently to melt, sinter, or otherwise fuse, to form a layer of the 3D object being generated. Portions of the layer of build material on which fusing agent was not applied generally will not heat up sufficiently to melt, sinter, or fuse.

In some examples, the controller 110 may also determine an amount of a fusing agent to apply based on an indication of density measured at a position. For example, the controller 110 may instruct a fusing agent distributor 124 to apply more fusing agent to areas with lower density than areas with high density to promote fusing. In some examples, based on properties of the fusing agent and build material 150, the controller 110 may instruct the fusing agent distributor 124 to apply less fusing agent to areas with lower density.

The fusing agent distributor 124 distributes a fusing agent that acts as a catalyst for determining whether application of energy, e.g., energy in the microwave wavelength, results in the fusing of the build material 151 on which the fusing agent has been applied. The locations at which the fusing agent distributor 124 applies fusing agent are determined to form portions of a 3D object or portions of multiple 3D objects. As such, successive layers of build material 151 are fused to form the 3D object or objects.

In some examples, the fusing agent enhances absorption of microwave energy from the energy source 126 to heat the layer of build material 151 to a temperature that is sufficient to cause the build material 150 upon which the fusing agent has been deposited to melt, fuse, cure, sinter, cause a reaction with another material, or otherwise coalesce prior to or as part of being joined. In addition, or alternatively, the fusing agent may be a binder that may absorb the microwave energy to become cured and thus cause the layer of build material 151 upon which the fusing agent has been applied to become joined together as the binder is fused, cured, or otherwise joined. In addition, as discussed herein the energy source 126 may apply energy at a level (and/or a wavelength) that may cause the layer of build material 151 upon which the fusing has been applied to be joined without causing the layer of build material 151 upon which the fusing agent has not been applied to be joined. For example, the controller may determine an amount of energy to apply to a position based on the impedance measurement provided by the impedance measurement circuitry 128 based on signals from sensor bar 122.

In some examples, the fusing agent distributor 124 may apply an ink-type formulation as a fusing agent. For example, the fusing agent distributor 124 be a thermal inkjet (TIJ) printhead, a piezoelectric printhead, or the like. The fusing agent distributor 124 may print, or apply, drops of an energy absorbing fusing agent to a layer of build material in a pattern based on a 3D object model of a 3D object to be generated by the 3D printing system 100. For example, a 3D object model may be sliced into a series of parallel planes, each slice being represented by a bitmap image representing the portions of each layer of build material to be solidified by the 3D printing system 100. In one example, those portions may represent portions of a layer of build material to which a fusing agent is to be applied. The ink-type fusing agent may be formulated to selectively absorb energy at a frequency and wavelength applied by the energy source 126. For example, the fusing agent may be selected to absorb microwave energy and convert that energy to heat to selectively fuse build material 150. In some examples, the fusing agent may be formulated to absorb infra-red light, near infra-red light, visible light, UV light, or energy at other portions of the electromagnetic spectrum.

In some examples, a detailing agent may be applied on the layer of build material 151 to assist in the formation of the portions of the 3D object. For example, a detailing agent may reduce the fusing of build material and therefore further define boundaries of a 3D object to be built. For example, a detailing agent may be a non-microwave absorbing material such that the application of the microwave energy from the energy source 126 may not cause or may cause a relatively small amount of heating of the detailing agent and those portions of the layer of build material 151.

The build material 150 may include any suitable material for forming a 3D object including, but not limited to, plastics, polymers, metals, nylons, and ceramics and may be in the form of a powder, a powder-like material, a fluid, a gel, or the like. The build material 150 may be spread in a layer of build material 151 by a spreader 146. A predetermined amount of build material 150 may be provided to a spreader 146 through a build material hopper 148. The spreader 146 then spreads the build material 150 into a layer of build material 151 on a build platform 132. The spreader 146 may form layers of build material on a build platform 132. For example, the spreader 146 may be a recoater which is to spread a volume of build material 150, such as a powdered, particulate, or granular type of build material, over a build platform 132 of a build unit 130. The build material 150 may be any suitable type of build material, including plastic, and ceramic build materials.

In some examples, the spreader 146 may be in the form of a counter-rotating roller, a wiper, blade or any other suitable spreading mechanism. In one example the spreader 146 may be a build material dispersion device that directly forms, for example through overhead deposition, a layer of build material on the build platform 132. In some examples, the spreader 146 may move across the build platform 132 in the same direction as the carriage 120 housing the energy source 126, the fusing agent distributor 124, and the sensor bar 122. In other examples, the spreader 146 may move in a direction perpendicular (or other any other direction) to the movement of the carriage.

The volume of build material 150 may be formed on a build material supply platform by the build material hopper 148. In some examples, other suitable mechanisms for providing build material, such as a moveable vane, may form the build material 150 for spreading. The volume of build material 150 may be formed as a volume of build material having a substantially uniform cross-section along the length of the build material supply platform. After spreading, any excess build material may be reused in a reverse spreading process or recovered for use in a subsequent operation.

The build platform 132 is coupled to a support element 134 which is coupled to a drive module 136 to control the build platform 132. In one example the support element 134 comprises a lead screw threaded through a fixed nut. Rotation of the lead screw by the drive module 136 thus causes the position of the build platform 132 to vary, depending on the direction of rotation of the lead screw. In another example, the support element 134 may be a hydraulic piston, and the drive module 136 may be a hydraulic drive system to vary the hydraulic pressure within the piston. In use, the drive module 136 is instructed, or is controlled, to lower the build platform 132 by an intended amount. The intended amount may be a predetermined layer thickness that is to be used during a 3D printing build operation. Due to inconsistencies in the operation of the spreader 146, the drive module 136, or the build material 150, the density in a layer of build material 151 may vary across its surface. In order to compensate for differences in the density, the controller 110 varies an amount of energy provided by the energy source 126.

In instances in which the build material 150 is in the form of a powder, the layer of build material 150 may be formed to have dimensions, e.g., widths, diameters, or the like, that are generally between about 5 μm and about 100 μm. In other examples, the build material 150 may have dimensions that may generally be between about 30 μm and about 60 μm. The build material 150 may generally have spherical shapes, for instance, as a result of surface energies of the particles in the build material and/or processes employed to fabricate the particles. The term “generally” may be defined as including that a majority of the particles in the build material 150 have the specified sizes and spherical shapes. In other examples, the term “generally” may be defined as a large percentage, e.g., around 80% or more of the particles have the specified sizes and spherical shapes. The build material 150 may additionally or alternatively include short fibers that may, for example, have been cut into short lengths from long strands or threads of material,

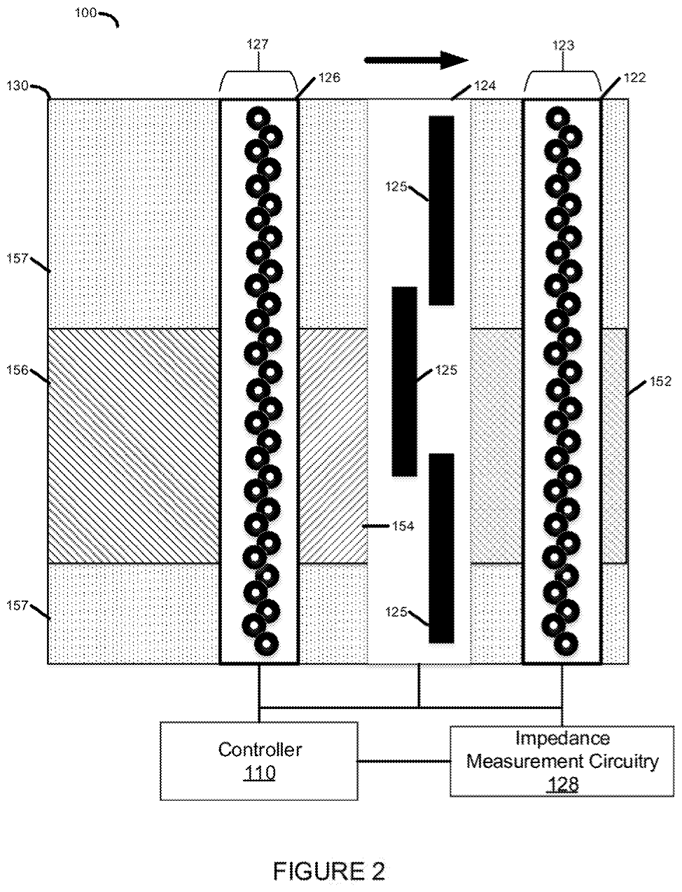

FIG. 2 is a block diagram illustrating a top down view of a 3D printing system 100 according to examples. It should be understood that the 3D printing system 100 depicted in FIGS. 1 and 2 may include additional components and that some of the components described herein may be removed and/or modified without departing from the scope disclosed herein. The 3D printing system 100 shows a build unit 130 with a layer of build material spread. The layer of build material includes a first portion 152, a second portion 154, and a third portion 156 as described with above with respect to FIG. 1. The 3D printing system includes a sensor bar 122, a fusing agent distributor 124 and an energy source 126. The sensor bar 122 provides sensor responses to impedance measurement circuitry 128 that generates a measurement of impedance for controller 110. In some examples, the impedance measurement circuitry 128 incorporated as part of the sensor bar 122. The controller 110 uses the impedance measurements as an indication of the density of the build material. The controller 110 uses the indication of density at different positions to determine an amount of energy to apply to those positions.

As shown in FIG. 2, the sensor bar 122 includes an array of sensors 123. Each sensor may provide a sensor response indicating a density of build material at intervals as the sensor bar 122 is scanned across the build unit 130. Accordingly, the sensor bar 122 provides density information for positions that will have energy applied by energy source 126. In some examples, the controller 110 is aware of regions of the build unit 130 where a 3D object will be fabricated. The controller 110 may use that information to instruct the sensor bar 122 to determine an impedance in the areas having a 3D object fabricated in the layer of build material, but not activate the sensor bar 122 in areas where the 3D object is not fabricated.

In some examples, each sensor in the array of sensors 123 is a microwave emitter that senses density by emitting microwave energy as the sensor bar 122 moves across the build platform. The tips of microwave emitters may be positioned in relatively close proximities to the build unit 130 such that the build material is within energy fields generated from the microwave emitters. The build material, frequency, and/or the wavelength of the energy provided by the sensor bar 122 may be selected such that the energy may have a minimal heating effect on the build material while providing an impedance that can be measured by the impedance measurements circuitry 128. The impedance may be measured based on energy reflect by the build material. In some examples, the sensor bar 122 may include different or additional types of sensors. For example, sensor bar 122 may include optical, infrared, or other sensors that determine density of the build material.

In some examples, the sensor bar 122, the fusing agent distributor 124, and the energy source 126 may be moved across the build platform by a carriage (not shown), with the sensor bar 122 on the leading side of the carriage as it moves. The fusing agent distributor 124 and energy source 126 then pass over the same positions that were measured by the sensor bar 122. The controller 110 instructs the fusing agent distributor 124 where to apply fusing agent in order to fabricate a 3D object. As shown, the fusing agent distributor 124 may include applicators 125 that span the width of the build unit 130 allowing the 3D printing system 100 to apply fusing agent to the build material in a single pass. In some examples, a 3D printing system may have a sensor bar 122, fusing agent distributor 124, or energy source 126 that do not span the width of the build unit 130 and may perform multiple passes for a single layer of build material. In some examples, the applicators 125 may be print heads that selectively apply a fusing agent. The controller 110 may instruct application of fusing agent based on a 3D model. In some examples, the controller 110 may determine an amount of fusing agent to apply based on the density measurement. For example, more or less fusing agent may be applied based on the amount of build material in a unit of volume near the surface of the build unit 130.

Following application of the fusing agent, the energy source 126 is passed over the build material to selectively apply energy to the build material. In some examples, the controller 110 may instruct the energy source 126 to apply energy to areas having fusing agent applied, but not to other areas. For example, second region 154 may have fusing agent applied, while region 157 does not have fusing agent applied. Accordingly, the controller 110 may instruct the energy source 126 to provide energy to those areas having fusing agent applied. In some examples, the energy source 126 includes an array of microwave emitters 127 that selectively apply energy. The microwave emitters 127 may provide energy through a microwave emitter tip near the surface of the build material. The fusing agent absorbs the energy and heats the build material to fuse or otherwise join the build material. In some examples, the energy source 126 may provide other types or wavelengths of energy to cause fusing of the build material. For example, infrared, ultraviolet, or other energy may be applied by the energy source 126 to cause fusing.

In some examples, the sensor bar 122 and the energy source 126 may each include the same components and the ability to operate as either a sensing or fusing component. For example, the sensor bar 122 and the energy source 126 may each include an array of microwave emitters that can be activated by the controller 110 to perform sensing or energy application functions. The controller 110 may operate the sensor bar 122 and the energy source 126 differently depending on the direction of motion. For example, a microwave emitter array on the leading edge of the carriage with respect to the direction of motion may act as a sensor bar 122, while the microwave emitter array on a trailing edge of the carriage with respect to the direction of motion may act as an energy source 126. The controller 110 may reverse operations as the carriage moves in the opposite direction. This may improve printing by enabling printing in each direction and reducing the number of passes over the build unit 130. In some examples, the sensor bar 122 and energy source 126 may include different types of sensing and energy sources and continue to enable bidirectional printing. For example, each may include an array of sensors and an array of energy sources.

Microwave energy emitters of a sensor bar 122 and energy source 126 may be arranged in a direction that is perpendicular to or nearly perpendicular to the scan direction of a carriage. For example, the sensor bar 122 and energy source 126 may be arranged substantially perpendicular to a scanning direction of a carriage to which they are mounted. In some examples, microwave energy emitters may be arranged in offset columns such that the microwave energy emitters in one of the columns may be offset with respect to the microwave energy emitters in another one of the columns. The microwave energy emitters in the respective columns may be offset with respect to each other such that the microwave energy emitters may emit energy across a large swath of the build platform unit. In addition, the microwave energy emitters may be individually controllable and may have relatively high resolutions. By way of example, the effective radiation diameters of the microwave energy emitters may be greater than around 2 mm and the tips may be in an array and may have spacing between them around 4 mm.

Microwave energy emitters may include a feed, such as a coax feed to receive microwave energy from the microwave energy source. For example, the microwave energy source may include a number of magnetron tubes to provide a determined amount of energy to the microwave emitters. In some examples, the microwave energy source may be coupled to one or more power splitters to provide the determined amount of energy through the microwave emitters. Microwave energy emitters may also include a resonator to couple with the feed and project microwave energy emitters through a tip of the microwave energy emitters. By way of example, components of the microwave energy emitters may be fabricated using solid copper, stranded copper, copper plated steel wire, other metals, and the like.

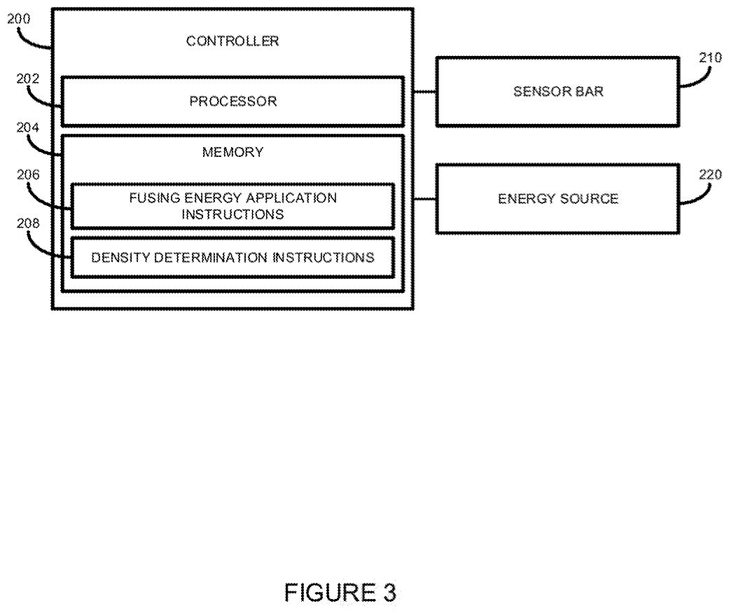

Referring now to FIG. 3, controller 200, according to an example, is shown in greater detail. The controller 200 includes a processor 202, such as a microprocessor or microcontroller. The processor 202 is electronically coupled to a memory 204 via a suitable communications bus (not shown). The memory 204 stores a set of machine-readable instructions that are readable and executable by the processor 202 to control a 3D printing system according to the instructions. For example, execution of the instructions may cause a method of operating the 3D printing system 100, as described with reference to FIGS. 1 and 2, to be performed. For example, any of the example methods described herein may be performed in response to execution of instructions stored in memory 204

In some examples, the memory 204 comprises fusing energy application instructions 206 that, when executed by the processor 202, cause an energy source 220 to selectively apply energy to build material. For example, the fusing energy application instructions 206 may instruct microwave energy emitters to emit energy to the surface of the build material. The instructions may indicate which microwave energy emitters to emit energy and an amount of energy to emit. The amount of energy to emit may be varied by changing the magnitude of a generated electromagnetic field or an amount of time that an electromagnetic field is applied at a position.

The memory 204 also includes density determination instructions 208. When executed by the processor 202, the density determination instructions 208 receive a sensor response from a sensor bar 210. The sensor response may include an impedance measurement received from microwave emitters in an array of microwave emitters. The density determination instructions 208 determine an indication of density of a layer of build material based on the received impedance. The sensor response provided by the sensor bar 210 may not measure an impedance throughout an entire deposited layer of build material, however, the impedance measurement from a surface portion of the layer may provide an approximation of density through the deposited layer of build material at that position. The density determination instructions 208 may include a relationship between the impedance measurement and an indication of density. Using the relationship, the density determination instructions 208 can generate an indication of density. For example, higher impedance at a position may indication higher density of build material at that position. The relationship between a sensor response and density may vary depending on selected materials and sensors in sensor bar 210. In some examples, sensor bar 210 may include different or additional sensors than microwave energy emitters. For example, the sensor bar 210 may include optical, infrared, or other sensors for determining density or other properties of a build material.

The fusing energy application instructions 206 may use the density determined at a position of build material to determine an amount of energy to apply at that position. For example, as the fusing energy application instructions 206 may instruct an energy source 220 to apply more or less energy at a position based on the measured indication of density. In some examples, the controller may also instruct a fusing agent distributor to apply more or less fusing agent at positions based on determined positions. In addition to consideration of density, the fusing energy application instructions 206 may instruct the energy source 220 to apply energy only to those positions that are to be fused to generate a 3D model. Selective application of varying amount of energy by energy source 220 may provide better fusing of positions that are too be fused with less unintentional fusing and reduced degradation of build material in non-fused portions of the build material.

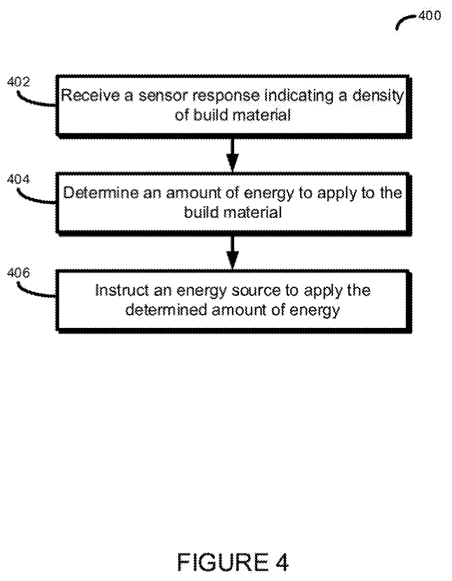

FIG. 4 illustrates an example flow diagram 400 that may be performed by a 3D printing system. For example, the flow diagram may be performed by a 3D printing system as described with reference to FIGS. 1 and 2 above. The flow diagram may be performed based on instructions from a controller as described with reference to FIG. 2, for instance.

In block 402, a 3D printing system receives a sensor response indicating a density of build material at a plurality of positions of a layer of build material on a build platform. The sensor response is received from a sensor bar having a plurality of sensors. The sensor bar is scanned across a build platform to determine density of build material. To prevent interference and inaccuracy from any fusing agent, the sensor bar may be scanned across the build material prior to application of fusing agent.

In some examples, the sensor response may be a set of impedances measured at the plurality of positions be an array of microwave emitters. For example, as an electromagnetic field generated by a microwave emitter interacts with the build material, impedance measurement circuitry may measure an impedance resulting from the interaction. That impedance may be used as an indication of density of the build material at a position local to the microwave emitter. While the electromagnetic field may not equally penetrate the local area, the overall impedance measured may be used to indicate density of the area. In some examples, other sensors, such as optical, laser, infra-red, ultra-violet, or the like may be used to determine a density of build material.

In some examples, to generate the sensor response, the sensor bar may deliver a first signal to a first microwave energy emitter. The sensor bar may then receive an energy feedback signal corresponding to energy reflected back into the first microwave energy emitter. The sensor bar or impedance measuring circuitry can then determine, based on the received energy feedback signal, an impedance of the layer of build material.

In block 404, the 3D printing system determines, based on the sensor response, an amount of energy to apply to the plurality of positions. For example, the sensor response for a position may be interpreted as a particular density for that position. The 3D printing system can use a relationship between density and the amount of energy that causes fusing of the build material at that density to determine an amount of energy for the position. The determination may be made based on a regression between the fusing energy and the density, based on a look-up table, or based on other processes. In some examples, the determination of the amount of energy also includes other factors. For example, the amount of energy may be generated based on the density and modified based on the amount of build material to be fused in adjacent position. For example, residual heating from previous layers of build material, heating of areas in proximity of the position, or other residual heating may affect the heating of the build material at a particular position. Accordingly, the 3D printing system may modify the amount of energy to apply based on the density determination as well as the 3D model of the object to be printed.

In some examples, the 3D printing system may also determine an amount of fusing agent to apply to a position. For example, a position having a particle density of 40% with a small amount fusing agent applied may fuse having the same amount of energy applied as another position having particle density of 60% and a larger amount of fusing agent applied. Therefore, the 3D printing system may determine an amount of fusing agent to apply in addition to or rather than determining an amount of energy to apply. This may enable the same energy application at positions to be fused while uniformly fusing the build material. In some examples, the 3D printing system may instruct a fusing agent distributor to change the amount of fusing agent to apply by changing a density of printed fusing agent or contone levels of printed fusing agent.

In block 406, the 3D printing system instructs an energy source to apply the determined amount of energy to positions. For example, a controller may access a stored density for a position of build material that was generated based on the sensor response. As an energy source is moved to that position, the controller instructs the energy source to apply the determined amount of energy. In some examples, the energy source is a microwave energy emitter that provides the instructed energy. The controller may use active feedback of reflected energy to modify the amount of energy applied by the energy source. For example, if the microwave energy emitter receives an energy feedback from the build material at a particular magnitude or phase, that may act as an indication that the building material has reached a temperature to induce fusing and the controller may stop the energy emission.

The processes described with respect to the example flow diagram 400 may complete a layer of 3D printing within a build unit. Accordingly, a 3D printing system may repeat the processes with successive layers to generate a completed 3D printed object having a shape as specified by a 3D object model. In various implementations, the processes shown in FIG. 4 may be performed in a different order. In addition, in implementing the example flow diagram 400, a 3D printing system may perform fewer or additional processes than shown. For example, the 3D printing system may apply additional agents to improve 3D printing or apply additional characteristics to regions or voxels of the 3D object.

In various examples, a 3D printing system prints bi-directionally across a build unit. The sensor bar and energy source may reverse roles in one direction than the other direction. For example, microwave energy emitters may act as a sensor bar when operated on the leading side of a carriage as it operates in a first scanning direction and an energy source when operated on the trailing side of a carriage as it operates in a second scanning direction.

It will be appreciated that examples described herein can be realized in the form of hardware, software or a combination of hardware and software. For example, the controller 110 described in FIGS. 1 and 2 or controller 200 described in FIG. 2 may be implemented in a combination of hardware or software. Any such software may be stored in the form of volatile or non-volatile storage such as memory 204 described with reference to FIG. 2. For example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. Accordingly, some examples provide a program comprising code for implementing a system or method as claimed in any claim and a machine-readable storage storing such a program.

The features disclosed in this specification (including any accompanying claims, abstract and drawings), and/or the operations or processes of any method or process so disclosed, may be combined in any combination, except combinations where at least some of such features and/or processes are mutually exclusive.

Each feature disclosed in this specification (including any accompanying claims, abstract, and drawings), may be replaced by alternative features serving the same, equivalent or similar purpose, unless expressly stated otherwise. Thus, unless expressly stated otherwise, each feature disclosed is an example of a generic series of equivalent or similar features.

What is claimed is:

1. A method comprising:
receiving a sensor response indicating a density of build material at a plurality of positions of a layer of build material on a build platform;
determining, based on the sensor response, an amount of energy to apply to the plurality of positions; and
instructing an energy source to apply the determined amount of energy to the plurality of positions.

2. The method of claim 1, wherein receiving the sensor response further comprises:
controlling delivery of a first signal to a first microwave energy emitter of a plurality of microwave energy emitters;
receiving an energy feedback signal corresponding to energy reflected back into the first microwave energy emitter; and
determining, based on the phase and/or amplitude of the received energy feedback signal, an impedance of the layer of build material.

3. The method of claim 1, wherein receiving the sensor response comprises receiving a plurality of signals from a plurality of microwave energy emitters.

4. The method of claim 1, wherein instructing the energy source comprises instructing a first microwave energy emitter to apply the determined amount of energy to a first position associated with a first sensor response of the plurality of positions.

5. The method of claim 1, wherein determining the amount of energy to apply further comprises:
determining that a first position is not to have a fusing agent applied; and
instructing the energy source to not apply energy to the first position in response to determining that the first position is not to have the fusing agent applied.

6. The method of claim 1, receiving the sensor response from a first array of microwave emitters as a carriage moves in a first direction and receiving the sensor response from a second array of microwave emitters as the carriage moves in a second direction.

7. A three-dimensional printing system comprising:
a sensor bar to sense a density of a build material applied to a build platform at a plurality of positions;
an energy source to selectively apply energy to a layer of build material to fuse the build material in selected areas having a fusing agent applied; and
a controller to:
receive a sensor response from the sensor bar,
determine an amount of energy to apply to the plurality of positions based on the sensor response; and
instruct the energy source to apply the determined amount of energy to the plurality of positions.

8. The three-dimensional printing system of claim 7, wherein the sensor bar comprises a plurality of microwave energy emitters and the sensor response comprises impedance measurements from the plurality of microwave energy emitters.

9. The three-dimensional printing system of claim 7, wherein the energy source comprises a plurality of microwave energy emitters to emit microwave energy according to instructions from the controller.

10. The three-dimensional printing system of claim 7, wherein to determine the amount of energy to apply, the controller is further to:
determine that a first position is not to have the fusing agent applied; and
instruct the energy source to not apply energy to the first position in response to determining that the first position is not the have the fusing agent applied.

11. The three-dimensional printing system of claim 7, further comprising a carriage to move across the build platform in a scanning direction, wherein the sensor bar and the energy source are mounted substantially parallel to the carriage in a direction substantially perpendicular to the scanning direction.

12. The three-dimensional printing system of claim 7, wherein the controller is further to:
receive a second sensor response from the energy source;
determine a second amount of energy to apply to a second plurality of positions based on the second sensor response; and
instruct the sensor bar to apply the determined second amount of energy to the second plurality of positions.

13. The three-dimensional printing system of claim 7, wherein the controller is further to determine an amount of fusing agent to be applied based on the sensor response received from the sensor bar.

14. A three-dimensional printing apparatus comprising:
a carriage to move across a build platform in a first direction and a second direction;
a first array of microwave emitters mounted to a first side of the carriage;
a second array of microwave emitters mounted to a second side of the carriage; and
a controller to:
instruct the carriage to move across the build platform in the first direction;
receive a sensor response from the first array of microwave emitters;
determine an amount of energy to apply to a plurality of positions based on the sensor response; and
instruct the second array of microwave emitters to apply the determined amount of energy to the plurality of positions.

15. The three-dimensional printing apparatus of claim 14, wherein the controller is further to:
instruct the carriage to move across the build platform in the second direction;
receive a second sensor response from the second array of microwave emitters;
determine a second amount of energy to apply to a second plurality of positions based on the second sensor response; and
instruct the first array of microwave emitters to apply the determined second amount of energy to the second plurality of positions.
